(19) United States
(12) Patent Application Publication
(10) Pub. No.: US 2016/0125444 A1
(43) Pub. Date: May 5, 2016

(54) SYSTEMS AND METHODS FOR ENHANCED CUSTOMER LEAD GENERATION, CAPTURE, AND MANAGEMENT

(71) Applicant: RapidFunnel, Inc., Columbine Valley, CO (US)

(72) Inventors: Patrick Steven Shaw, Columbine Valley, CO (US); Kurtis Wayne Frank, Englewood, CO (US); Charles Lynn Pate, JR., Denver, CO (US)

(21) Appl. No.: 14/924,563

(22) Filed: Oct. 27, 2015

Related U.S. Application Data
(60) Provisional application No. 62/073,767, filed on Oct. 31, 2014.

(51) Int. Cl. G06Q 30/02

(52) U.S. Cl. CPC G06Q 30/0214; G06Q 30/0269

(57) ABSTRACT

A computer-implemented system including a lead-engine server operatively coupled to an administrator computing system and a group of mobile devices. The lead-engine server may be configured to assign field user data among multiple campaign groups and define multiple, different campaigns for different groups of field users. The lead-engine server may also generate incentive programs and track the lead-generation input associated with the first field user. The lead-engine server may also be configured to generate a field-user specific website and communicate promotional information to potential leads that includes a link to the website.

### CROSS-REFERENCE TO RELATED APPLICATION(S)

This application is a nonprovisional patent application of and claims the benefit of U.S. Provisional Patent Application No. 62/073,767, filed Oct. 31, 2014 and titled “Systems and Methods for Enhanced Customer Lead Generation, Capture and Management,” the disclosure of which is hereby incorporated herein by reference in its entirety.

### FIELD OF THE INVENTION

Embodiments of this application relate, generally, to computer-implemented systems for generating and maintaining leads and, more specifically, to computer-implemented systems for capturing lead information and maintaining leads through a communication system.

### BACKGROUND OF THE INVENTION

While companies, businesses and other entities have numerous employees or other workers, often the creation of new customers is limited to the sales team or business development team. Traditionally, team members who are not specifically tasked with sales and new customer generation may represent a lost opportunity to the company because those team members may not be generating as many sales leads as could be possible. In particular, non-sales team members may have connections in the community, through family, and through meeting new people that may be potential sales leads.

There is a need for systems and techniques for enhancing new customer lead generation by employees or others associated with an organization using a computer-based lead-generation system.

### SUMMARY

Some example embodiments are directed to a computer-implemented lead management system. The lead management system is a lead-engine server operatively coupled to an administrator computing system. The lead-engine server may be configured to assign field user data among multiple campaign groups. The field user data may be associated with multiple field users and received from the administrator computing system. The lead-engine server may also define a first campaign for a first group of the multiple campaign groups and define a second campaign for a second group of the multiple campaign groups, the second campaign different than the first campaign. For a first field user associated with the first group, the lead-engine server may generate an incentive program that defines an award associated with a threshold level of lead-generation input associated with the first field user. The lead-engine server may also track the lead-generation input associated with the first field user. The system may also include a group of mobile devices operatively coupled to the lead-engine server by a computer network. The group of mobile devices may be configured to receive the lead-generation input from a respective field user, and transmit the lead-generation input to the lead-engine server.

In some embodiments, the lead-engine server is further configured to generate an electronic lead-generation form for the first field user, and transmit the lead-generation form to a mobile device associated with the first field user. The mobile device may be configured to receive the lead-generation form, add the lead-generation input using an input display based on the lead-generation form, and transmit the lead-generation input to the lead-engine server.

In some embodiments, the incentive program defines the award which is a first award associated with a first threshold number of new leads tracked using the lead-generation input. The incentive program may define a second award associated with a second threshold number of new leads, and a third award associated with a third threshold number of new leads.

In some embodiments, the first campaign includes a first discount offer rate, and first follow-up time schedule. The second campaign may include a second discount offer rate different from the first discount offer rate, and a second follow-up time schedule different from the first follow-up schedule. In some embodiments, the lead-generation input includes contact information for a lead, the contact information including one or more of: a lead name; an e-mail address; a company name; and/or a telephone number. In some embodiments, the first and/or second group is defined based on one or more of the following: a job title of a field user; a company of the field user; and/or a geographic region of the field user.

In some embodiments, the lead-engine server is further configured to generate a field-user-specific website using the user field data and at least one user-selected option. The mobile device and/or the lead-engine server is further configured to transmit a link to the field-user-specific website to a lead.

Some example embodiments are directed to a computer-implemented lead management system that includes a mobile device operatively coupled to a lead-engine server via a computer network. The mobile device may be configured to receive a campaign selection from a field user and display an input display based on a lead-generation form received from the lead-engine server over the computer network. The mobile device may be further configured to receive lead-generation input using the input display, and transmit the lead-generation input to the lead-engine server using the computer network. The lead-engine server may be configured to transmit a promotional communication to a lead associated with the lead-generation input in accordance with the campaign selection.

In some embodiments, the lead-engine server is further configured to receive the lead-generation input and credit an incentive to the field user based on a number of new leads. The lead-engine server may be further configured to generate a first award when the number of new leads exceeds a first threshold, and generate a second award when the number of new leads exceeds a second threshold that is greater than the first threshold. In some implementations, lead-engine server is further configured to generate a relative progress toward an award between multiple field users, and transmit an indication of the relative progress to the multiple field users.

In some embodiments, the lead-engine server is further configured to generate a field-user-specific website using at least one user-selected option. The promotional communication may include a link to the field-user-specific website. In some cases, the lead-engine server is further configured to track activity on the field-user-specific website. In some cases, the lead-engine server is further configured to track purchase activity related to the promotional communication. The promotional communication may include a discount rate associated with the campaign selection. In some cases, the lead-engine server is configured to transmit subsequent promotional communications in accordance with a communication schedule associated with the campaign selection.

Some example embodiments are directed to a computer-implemented system for generating customer leads over a network. The system may include a plurality of mobile devices operatively coupled to the network. The mobile devices may have a processor configured to display to a field user one or more promotions for offering to a lead, and receive lead-generation input from the field user. The system may also include a server coupled to the network, the server having a lead engine configured to receive the lead-generation input from the mobile devices, transmit one or more promotions to each lead. A database may be coupled with the server. The database may be configured to store the lead-generation input and promotional information associated with the one or more promotions.

In some embodiments, wherein the promotional information includes a link to a field-user-specific website, the server may be configured to define multiple promotional campaigns, each promotional campaign associated with a different group of field users. The promotion may be defined in accordance with a promotional campaign that is associated with the field user that received the lead-generation input.

In some embodiments, the server is configured to track lead-generation input received from the plurality of mobile devices. The server may also be configured to update a progress for each mobile device using the lead-generation input. The server may also be further configured to generate a relative progress between two or more field users based on the received lead-generation input, and transmit an indication of the relative progress to two or more field users.

### BRIEF DESCRIPTION OF THE DRAWINGS

FIG. 1 illustrates an example of a block diagram of a computer-implemented system including a lead engine, in accordance with one embodiment of the present invention.

FIG. 2 illustrates an example of a process for establishing an electronic lead-generation program, in accordance with one embodiment of the present invention.

FIG. 3 illustrates an example of a process for collecting lead information and awarding incentives, in accordance with one embodiment of the present invention.

FIG. 4 illustrates an example of a process for determining incentives, in accordance with one embodiment of the present invention.

FIG. 5 illustrates various examples of electronic promotional campaigns that can be offered by a field user, in accordance with one embodiment of the present invention.

FIG. 6 illustrates various examples of incentive programs that can be offered to a field user by a company, in accordance with one embodiment of the present invention.

FIG. 7 illustrates various examples of campaign groups that can be defined by a company, in accordance with one embodiment of the present invention.

FIG. 8 illustrates various examples of lead-generation forms that can be defined by a company for use by a field user when interacting with a potential lead, in accordance with one embodiment of the present invention.

FIG. 9 illustrates various examples of lead tracking, in accordance with one embodiment of the present invention.

FIG. 10 illustrates various examples of campaign sharing, in accordance with one embodiment of the present invention.

FIG. 11 illustrates various examples of creating personalized websites, in accordance with one embodiment of the present invention.

FIGS. 12-25 illustrate various examples of computer display screens illustrating various features of embodiments of the present invention.

### DETAILED DESCRIPTION

Disclosed herein are various computer-implemented systems and methods for enhanced customer lead generation, capture, and management. As described herein, various embodiments of the invention include a lead engine that collects various items of data and information (referred interchangeably herein as lead data or lead-generation input, which may include but is not limited to customer information, social network data, personal history information, employment information, etc.) relating to a potential lead.

Embodiments of the present invention provide a multi-tenant web-based marketing system and computer-implemented methods and related applications that enable organizations or individuals to utilize their largest and most valuable asset (their employees) to increase lead generation, build email marketing lists and craft and manage marketing campaigns to those lists. Embodiments of the present invention can change the culture of an organization by breaking down the barriers that often exist between sales and marketing and “the rest of the organization.” Embodiments of the present invention encourage all members of an organization to get involved in lead generation and become brand advocates for the organization.

As described herein, any employee (“field user”) can capture leads through the use of a mobile device, such as a smart phone, tablet or desktop computer. A field user can send, or cause to send, promotional communication, a personalized marketing message, and/or offer to the prospect and store the leads on a server or database for future marketing activities. The leads may be tracked and captured leads may be flagged by capture date, the user who captured the lead and/or the marketing message(s) sent. Organizations can incentivize field users to collect more leads by offering awards and recognition for top performers or set goals for each field user to achieve.

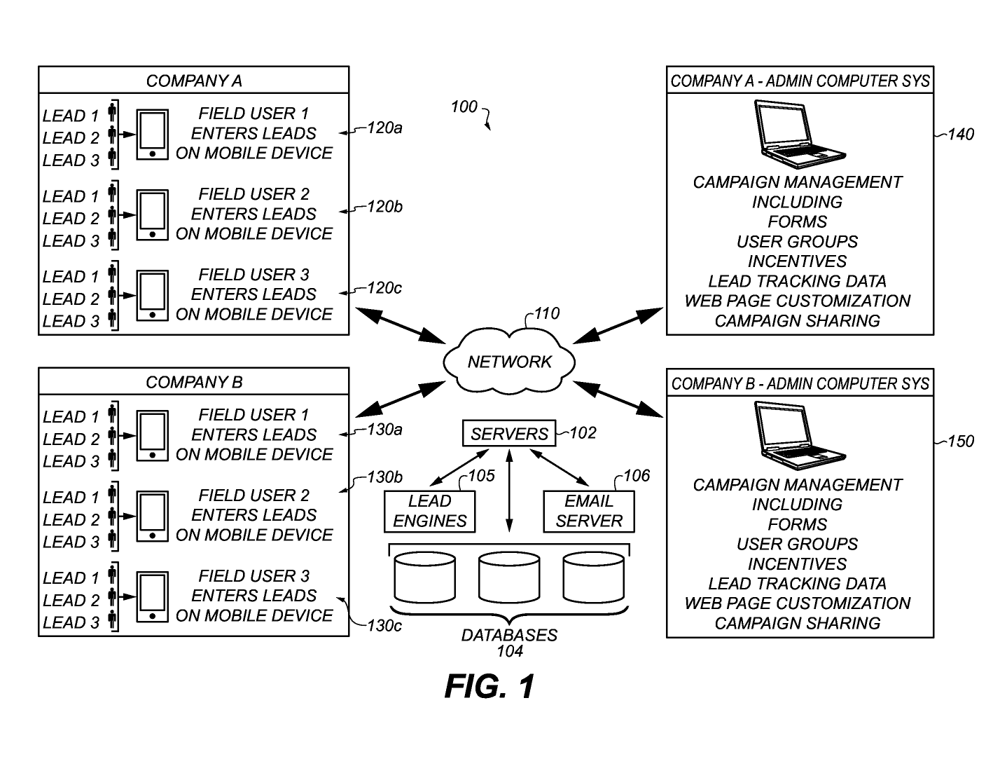

FIG. 1 illustrates an example of a block diagram of a system 100 which may include components of a computer-implemented lead-engine or computer-implemented lead-management system, in accordance with embodiments described herein. A lead engine may be implemented in a computing system as a lead-engine server 105 configured to execute computer program modules, code products, or modules using a computer processor or other computing device. The lead-engine server 105 may be in communication with one or more administrator computing systems 140, 150. As shown in FIG. 1, the administrator computing systems 140, 150 may be company-based administrator computing systems providing access to, in this example, Company A′s Administrator Account and Company B′s Administrator Account. The lead-engine server 105 may also be in communication with one or more mobile devices 120a-c, 130a-c associated with field users of a respective company, and with one or more leads that have contact or association with the field users.

In FIG. 1, a plurality of field users and leads utilize mobile devices 120a-c 130a-c such as mobile phones, smart phones, personal computers, tablet computers, smart TVs, or other computing devices to access a network 110, which may include the Internet. The field user's mobile devices 120a-c 130a-c may include GPS or other locational information. As described herein, the field user's mobile device 120a-c 130a-c may be provided with an application program or other computer code to interact with the lead-engine server 105 and/or the administrator computing systems 140, 150, and may perform one or more of the operations or functions described herein.

As shown in FIG. 1, the lead-engine server 105 is coupled with and in communication with a computer network 110 (including the Internet) through one or more intermediate servers 102, and is also securely coupled with a plurality of databases 104. The lead-engine server 105 may be implemented using computer program modules, code products, or modules running on a server or other computing device. The plurality of databases 104 may be implemented using any conventional database technology, including technology that securely stores data (such as through encryption) in redundant locations such as, but not limited to, RAID storage devices, network attached storage, or any other conventional databases.

The lead-engine server 105 may also be operatively coupled to one or more e-mail servers 106 via the computer network 110 or other electronic communication. The lead-engine server 105 may be configured to transmit e-mail messages to one or more of the mobile devices 120a-c, 130a-c using the e-mail server 106. Similarly, the lead-engine server 105 may be configured to transmit text messages (e.g., SMS messages) or other forms of electronic communications with the mobile devices 120a-c, 130a-c using one or more other types of intermediate communication systems or servers, including a cellular communication network or other similar systems configured for conducting electronic communications.

The lead-engine server 105 may implement one or more of the operations, processes, or process steps as described herein, and may include other operations or process steps as desired depending upon the particular implementation. The lead-engine server 105 may gather information from the administrator computing systems 140, 150, mobile devices 120a-c and 130a-c associated with the field users, computing devices associated with leads, and store such information in a secure manner on the one or more database 104.

As shown in FIG. 1 and described herein, a company (such as Company A or B shown in FIG. 1) may establish various electronic promotions and campaigns, form campaign groups of field users, manage forms for obtaining data relating to prospective leads, provide incentives to field users for generation and sales to leads, track leads and their respective activity and purchases, provide personalized webpages for field users for access by their respective networks of perspective leads, and share campaigns across various groups or field users within their company.

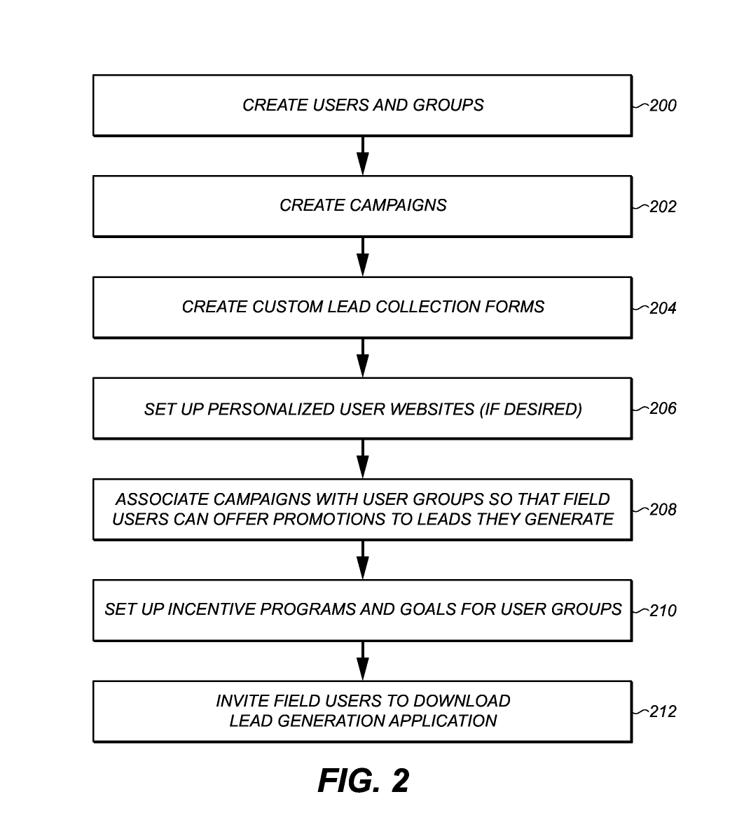

FIG. 2 illustrates an example of a process for establishing an electronic lead-generation program, in accordance with one embodiment of the present invention. In one embodiment, the process of FIG. 2 allows users the ability to collect leads utilizing their mobile device (e.g., smart phone) using an Android application, iPhone application, or responsive mobile interface from a tablet or other smartphone device, or a desktop interface for lead collection. The process manages all opt-in and opt-out features to facilitate compliance with all federal anti-spam laws; and the process manages all monitoring of replicated data meaning prospects/leads will never be entered into the same list twice. Customers (e.g., field users) will have the ability to manage all leads in their account and utilize the process and interfaces as a simple CRM.

In one example, a field user downloads a mobile application program and, after setting up an account, can start loading prospects immediately. When they meet a prospect and gather some initial information, they may choose the campaign that best fits the prospect's interest. The information collected from the prospect or lead may be referred to herein as lead-generation data or a lead-generation input. Additionally, the field user can choose to text the prospect, refer a business partner, send a coupon offer or other communication in accordance with one of a multitude of marketing campaigns offered by the company.

The employees (field users) within a company may continually load leads into the system over time, and the company may be continually targeting these leads for conversion to sales. Each lead may correspond to a specific group and to a specific campaign within that group. The lead may be more targeted and was generated through a one-on-one personal contact, which may make the quality of the lead substantially higher.

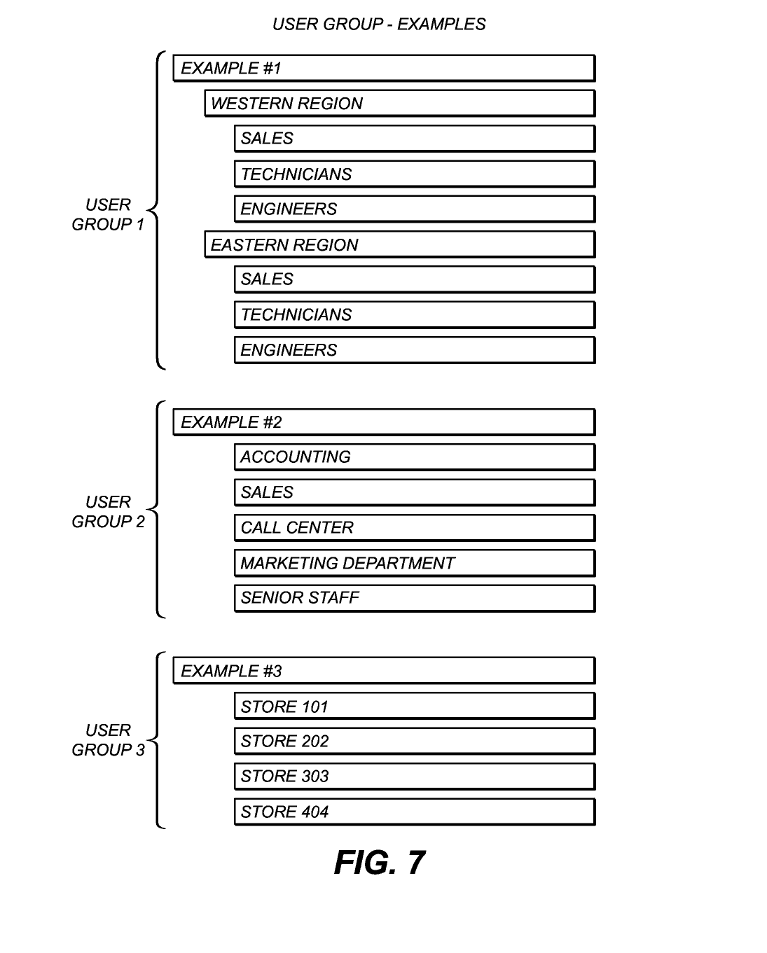

At operation 200 of FIG. 2, one or more campaign groups of field users may be created. In one example, campaign groups can include any set or grouping of field users of an organization or company. The field users may be represented by field user data stored in a company-based administrator computing system. The filed user data may be assigned among multiple campaign groups in accordance with a group definition or criteria. FIG. 7 illustrates examples of campaign or user groups defined by company and/or a geographic region (e.g., field users of the Western Region and Eastern Region of a company), and may also be defined by job title of the field user (e.g., groups of sales, technicians and engineers). In another example, campaign or user groups may be defined according to company department, such as the accounting department, sales department, call center, marketing department, and senior staff. In another embodiment, the campaign or user groups may be defined by various stores, branches, or divisions of the company, such as Store 101, 202, 303, 404, etc. It is understood that these campaign or user groups are provided by way of example only, and that various other groups may be defined and utilized depending upon the particular implementation.

In one example, embodiments of the present invention allow customers the ability to create an infinite number of campaign groups. At higher levels of service, the customer will possess the ability to create an infinite number of nested sub-campaign groups within their primary campaign groups. Individual users are also allowed to be in more than one group or sub-group at a time. This feature allows the customer the ability to set up unique incentives, awards and recognition programs or set goals on a department or group-by-group basis, as well as report and monitor performance on a department or group-by-group basis. Campaign groups can also include or define various campaigns, incentive programs, tracking schemes, who they are competing against, etc. In one example, members of the group are decided by the company and meet criteria defined by an initial group definition or set-up. This feature allows the company to identify specific segments of users within a company and create campaigns, personalized websites, and incentive programs that may motivate that campaign group in a targeted fashion. For example, the accounting department, installation division, IT department, etc. all have different skill sets and approaches to a prospect that would be natural and comfortable. The marketing campaign and incentive offered can be uniquely assigned to groups, in one example. In some cases, each campaign group may be associated with a different campaign, which may include various types of promotions and/or communication schedules, as described herein.

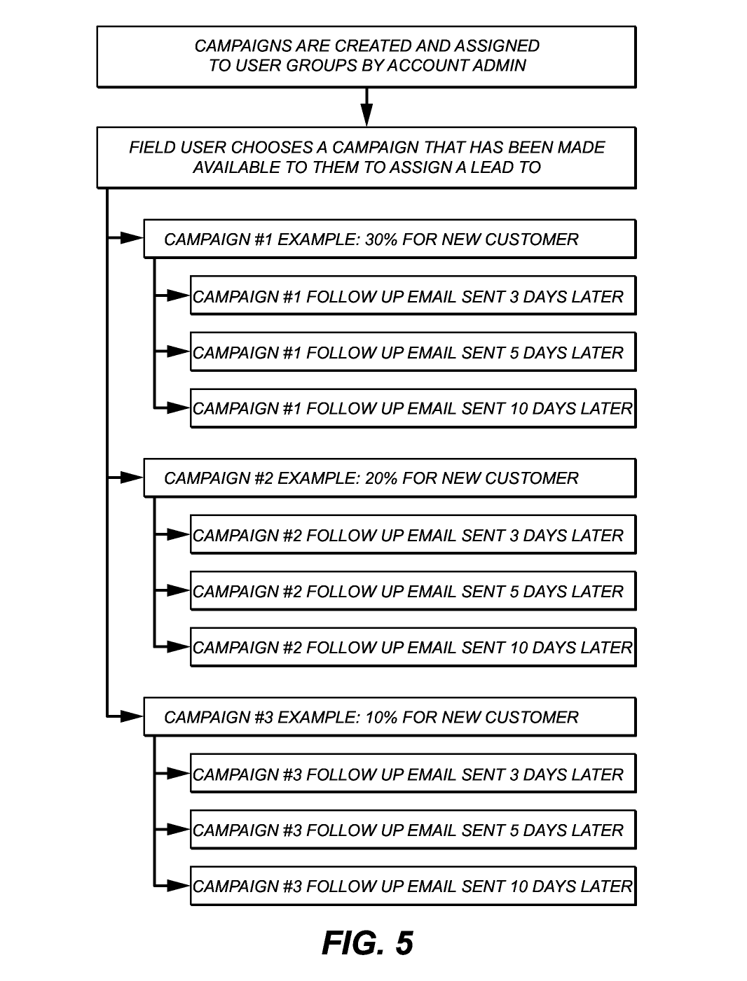

At operation 202 of FIG. 2, one or more electronic campaigns or promotions are created. The electronic promotions may be designed or adapted to be offered by field users to prospective leads, for discounts or other sales incentives to the prospective leads. Various examples of campaigns or promotions are illustrated in FIG. 5, and each promotion may be separately referenced or tracked. For instance, Promotion Number 1 may be 30% off any purchase by a new customer; Promotion Number 2 may be 20% off a purchase for a new customer; and Promotion Number 3 may be 10% off a purchase for a new customer. It is understood that these promotions are provided by way of example only, and that various other promotions may be utilized depending upon the particular implementation.

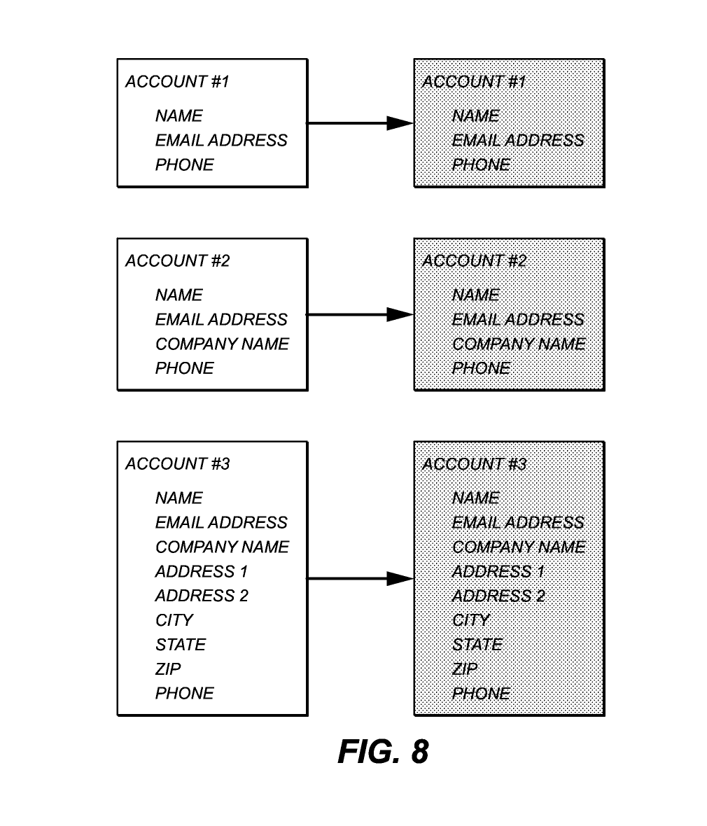

At operation 204 of FIG. 2, one or more custom electronic lead-generation forms may be created for use in gathering information relating to prospective leads. FIG. 8 illustrates various examples of electronic data forms (e.g., lead-generation forms) that can be defined by a company for use by a field user when interacting with a potential lead, in accordance with one embodiment of the present invention. For instance, an electronic form may be provided to a field user to obtain contact information, such as an e-mail address, name, and phone number of a prospective lead. In another example, an electronic form may be provided to a field user to obtain a name, an e-mail address, gender, and city/state of residence of a prospective lead. In another example, an electronic form may be provided to a field user to obtain a name, an e-mail address, age and interests of a prospective lead. It is understood that these electronic forms are provided by way of example only and that various other electronic forms may be defined and utilized depending upon the particular implementation.

In one example, embodiments of the present invention provide customers (e.g., field users) with the ability to customize the form fields they collect and/or require for each lead/prospect. In some cases, the customer may only want an email address. In other cases, the customer may want an email, phone and address. In one example, embodiments of the present invention allow for 15 (or more or fewer) form fields the customer has the ability to turn on or off depending on their organizations sales and marketing needs. For example, when the user opens their personalized mobile application and types in the prospects name they will also be able to choose from a score of other fields. Depending on the sophistication of the employee, their needs and the company's interest, the available data fields may be relevant. Other information can be captured as well, including zip codes, identifying price sensitivities, and other data that would allow for target marketing to particular needs, demographics or regions of the country.

At operation 206 of FIG. 2, personalized websites may be created (if desired) for use by a field user. A field-user-specific website may be created for each field user, if desired, so that the website has the field user's information—such as, but not limited to, the field user's photo, contact info, and current promotions. The field-user-specific website may be based on user field data (available through the company-based administrator computing system) and/or one or more user-selected options. The personalized website may also include one or more embedded links to promotions and offers, that are configured to be clicked-on or selected by the leads to access in order to receive discounts or other offers on the products and/or services of the company.

At operation 208 of FIG. 2, the promotions of operation 202 and the electronic forms of operation 204 are associated with the campaign groups of operation 200, so that field users can offer one or more of the promotions to prospective leads that they meet or know. For instance, in one example, the field users in the IT department of the company may be authorized to offer a first promotion defined by the company to their perspective leads; while the marketing department of a company may be authorized to offer other promotions defined by the company to their perspective leads. Thus, two or more campaign groups may be associated with campaigns that are different from each other.

At operation 210, incentive programs and goals may be set-up and associated with the various campaign groups. These incentive programs may include various incentives for field users, such as, but not limited to, the number of leads generated by a field user, the amount of business generated by a field user, or other incentives (such as described herein). The goals may include time-based goals, such as daily, weekly, monthly, quarterly and/or annual goals, or may include other benchmarks such as financial goals such as, but not limited, to revenues generated from leads or purchases made by leads. In some cases, the incentive programs include a competitive aspect and may compare the relative progress or incentives offered to various field users within a group or among different groups.

At operation 212, having set-up the characteristics for the lead-generation program for the company (or for portions of the company) such as, but not limited, to characteristics described with reference to operations 200-210, a lead-generation application program (such as a mobile application program operating on a mobile device such as a tablet or smart phone) can be distributed to field users for their use in generating and communicating with new leads. The lead-generation application can be customized with various settings and characteristics for a particular field user—for instance, with settings configured to load the data and settings that correspond to the particular field user such as the particular field user's contact list, available campaigns, associated campaign groups, incentives status, and other data/information specific to the field user. Along with or integrated within the lead-generation application may be one or more lead-generations forms transmitted from the lead-engine server. The lead-generation application may implement one or more of the operations, features, controls, screen elements or other aspects as described herein.

In this manner, it can be seen that the operations of FIG. 2 provide for a company to customize various electronic promotions, campaign groups, and the data to be obtained by field users regarding perspective leads.

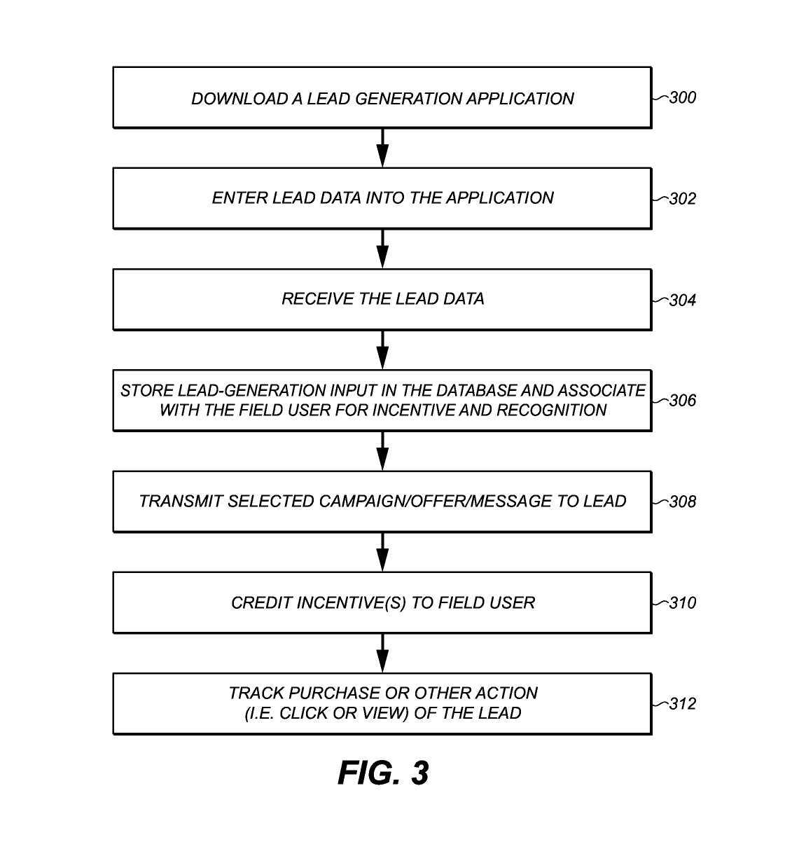

FIG. 3 illustrates an example of a process for collecting lead information and awarding incentives, in accordance with one embodiment of the present invention. At operation 300, a mobile application is transmitted to one or more field users for operation on the field user's electronic device. A lead-generation form may be integrated with the mobile application or may be transmitted to the mobile device separately from a lead engine. The mobile application interacts with the lead engine and may access portions of the data as authorized by the company administrator. If desired, operation 300 may also allow a field user to initially create their account, or to customize or update their account on the lead system. Note that operation 300 may occur in response to the field user accepting the invitation to download the lead-generation application of operation 212 of FIG. 2.

The mobile application provides controls and functionality for the field user to enter data relating to a prospective lead, so that one or more promotions can be sent to the prospective lead in order to attempt to create a customer relationship between the company and the prospective lead. The data relating to a prospect or lead may be generally referred to as lead-generation input. The lead-generation input may be entered using an input display that is defined, at least in part, on the lead-generation form. The mobile application may also display dashboards, status, or other information to the field user and their referral efforts and successes.

At operation 302, lead data is received, for instance from information gathered by a field user and entered into the application as lead-generation input. The lead-generation input may be transmitted through the mobile application to the lead engine via a computer network. At operation 304, lead-generation input is received by the lead engine.

At operation 306, the lead data (obtained from the lead-generation input) is stored and associated with the field user that obtained the lead data. The lead data may include data as shown in FIG. 8, such as, but not limited to, a perspective lead's name, contact information (e.g., e-mail address, telephone number, mailing address), gender, city and state of residence, age, interests, and other information.

At operation 308, upon receiving and storing the desired lead data, an offer, promotion, or promotional communication is electronically transmitted to the lead. In one example, an electronic promotion or offer is transmitted to an e-mail address of the prospective lead, or sent via text message to a mobile phone number of the prospective lead. The prospective lead can then utilize the promotion or offer to make a purchase from the company, such as an online purchase or a purchase at a retail storefront of the company.

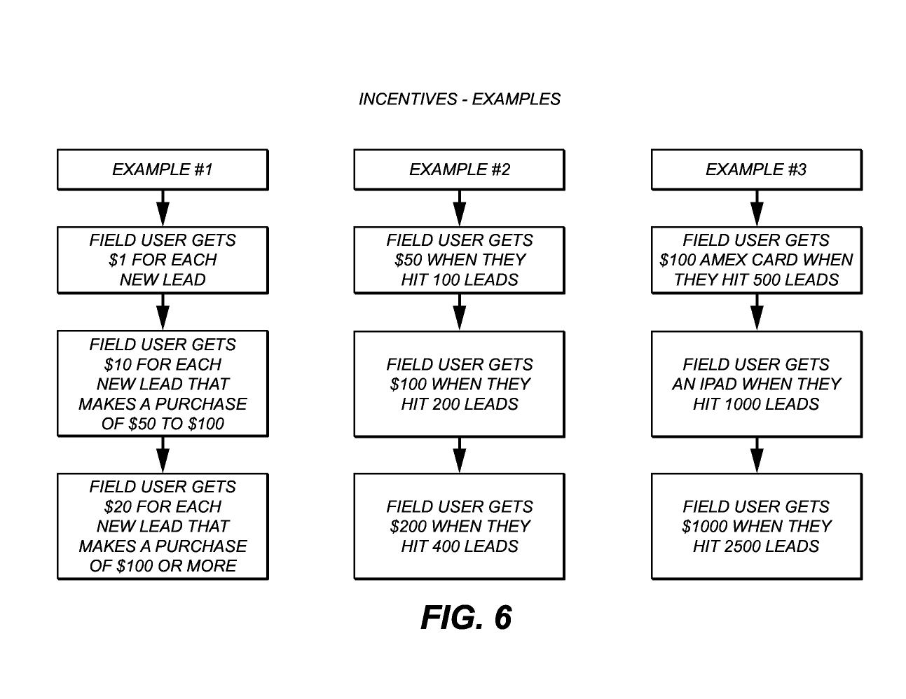

At operation 310, one or more incentives are awarded to/credited to the field user for their generation of the lead of operation 302 in accordance with an incentive program. For instance, incentives are credited or provided to a field user's account based on generation of a lead, or based on purchasing or other activity by the lead. Various incentives or incentive levels can be created by company as desired, and managed by the company through their administrative account. Incentives may take various forms as described herein, such as, but not limited to, cash awards, points, credits, goods, coupons, or other items of value for the field users. FIG. 6 illustrates example incentive programs including possible incentives, such as, but not limited to, $1 for each new lead generated; $10 for each new lead that makes a purchase of at least $50 to $100; and $20 for each new lead that makes a purchase of $100 or more. Another example of possible incentives may be (but not limited to) $50 when the field user generates 100 new leads; $100 when the field user generates 200 new leads; and $200 when the field user generates 400 new leads. Another example of possible incentives may be (but not limited to) $100 Amex card when the field user generates 500 new leads; a new iPad or other item when the field user generates 1000 new leads; and $1,000 when the field user generates 2,500 new leads. It is understood that these incentive amounts are provided by way of example only and that various other incentives may be defined and used depending upon the particular implementation.

At operation 312, activity of the prospective lead is tracked. The interactions or transactions related to the promotion may be tracked by the system. In one example, for instance, if a prospective lead makes a purchase utilizing the electronic promotion transmitted to the prospective lead at operation 308, such information relating to the purchase is tracked by operation 312. In another example, if a prospective lead clicks on a link or otherwise accesses electronic information available online related to products or services of the company, such information is also tracked.

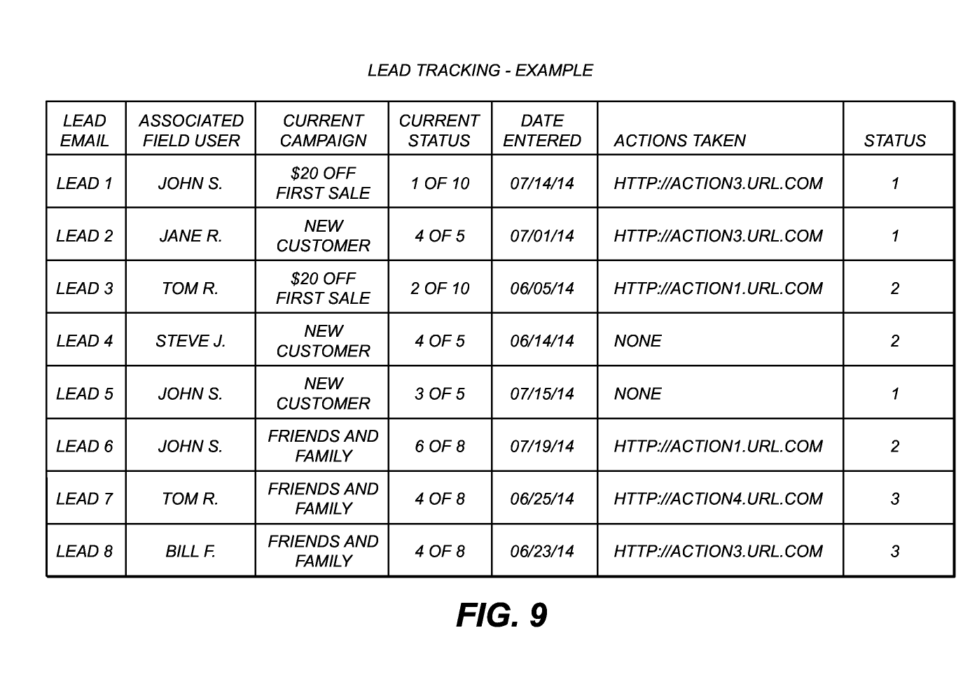

FIG. 9 illustrates various examples of tracking activity by a prospective lead. This information may be tracked and stored by the lead engine in the databases shown in FIG. 1. For instance, Lead #1 was referred by Employee/Field User John S., and the status of the lead is at Status 1 of 10 using Campaign/Offer $20 off first sale, dated Jul. 14, 2014. As another example, Lead #2 was referred by Employee/Field User Jane R., and the status of the lead is at Status 4 of 5 using Campaign/Offer “New Customer” dated Jul. 1, 2014. As another example, Lead #3 was referred by Employee/Field User Tom R. and the status of the lead is at Status 2 of 10 using Campaign/Offer $20 off first sale, dated Jun. 5, 2014. As another example, Lead #4 was referred by Employee/Field User Steve J. and the status of the lead is at Status 2 of 10 using Campaign/Offer “New Customer”, dated Jun. 14, 2014. As another example, Lead #5 was referred by Employee/Field User John S. and the status of the lead is at Status 3 of 5 using Campaign/Offer “New Customer”, dated Jul. 15, 2014. As another example, Lead #6 was referred by Employee/Field User John S. and the status of the lead is at Status 6 of 8 using Campaign/Offer “Friends and Family” dated Jul. 19, 2014. As another example, Lead #7 was referred by Employee/Field User Tom R. and the status of the lead is at Status 4 of 8 using Campaign/Offer “Friends and Family” dated Jun. 25, 2014. As another example, Lead #8 was referred by Employee/Field User Bill F. and the status of the lead is at Status 4 of 8 using Campaign/Offer “Friends and Family” dated Jun. 23, 2014.

Additional data fields can be tracked, as shown in FIG. 9, such as “Actions Taken” which shows, for example, the URLs that the new lead clicked through or if no action has been taken by the lead. It is understood that this tracking is provided by way of example only, and that various other data or information may be tracked in other forms depending upon the particular implementation.

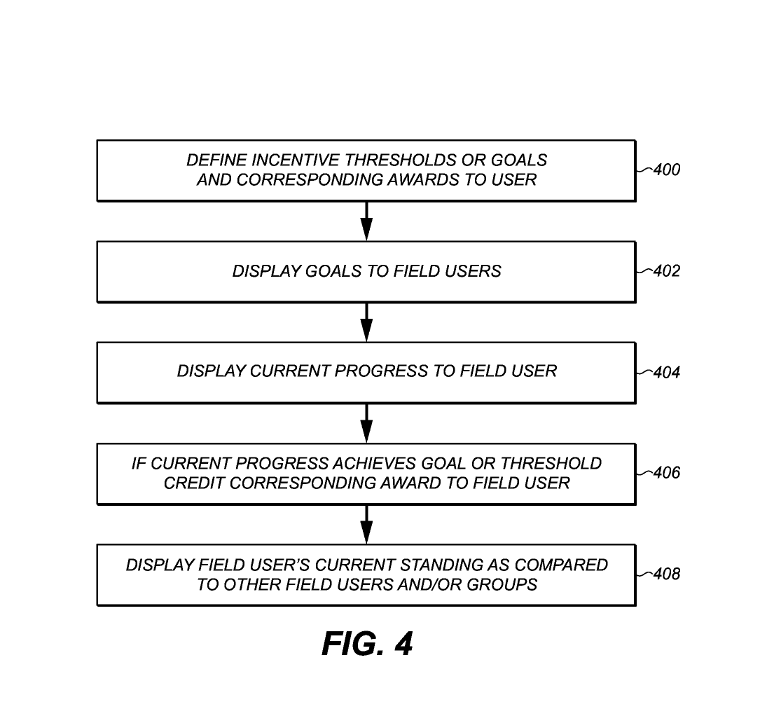

FIG. 4 illustrates an example of a process for determining incentives and recognition for lead generation, in accordance with one embodiment of the present invention. At operation 400, incentive programs are defined by the company. In one example, both incentive amounts and the required thresholds or goals for reaching the incentives are defined, and they may be defined based on campaign groups. For example, an incentive may be created for a field user to be awarded $5 for each new lead created or threshold number of new leads created. Another incentive may be created if the lead makes a purchase. Another incentive may be created if the lead makes a number of purchases. Another incentive may be created if the lead makes a number of purchases within a particular timeframe. Another incentive may be created if the lead remains a customer of the company for a specified duration of time. The amounts and types of incentives created, along with the thresholds associated with the incentives, will vary depending upon the implementation and as desired by the company. These incentives may be defined with respect to a particular campaign group—and may vary across different campaign groups within a company. For instance, if the sales team campaign group generates a new lead, an incentive may be defined at a $1 level, wherein if the accounting team campaign group generates a new lead the incentive may be defined at a $5 level. In addition, the incentives may be progressive and define different awards at increasing or progressive threshold levels. For example, an incentive program may define a first award at a first threshold number of new leads, a second award at a second threshold number of new leads, a third award at a third threshold number of new leads, and so on. The differing levels of incentives may be defined in order to incentivize specific behaviors within the different campaign groups of the company.

At operation 402, the goals and/or incentive levels may be displayed to the field user on the field user's device. For instance, goals may be established of generating five new leads per week with an award of $20, and this goal may be displayed on the field user's electronic device.

At operation 404, the current level or status of the field user's achievements relative to the goals may be displayed on the field user's device. For instance, if the field user has generated three new leads this week, this level of achievement may be displayed on the field user's electronic device.

At operation 406, if the current level of the field user has achieved a goal, a corresponding award is electronically credited to the field user. For instance, if the field user generated five new leads this week, an award of $20 can be electronically credited to the field user's account.

At operation 408, the current level or status of the field user's achievements relative to other field users in their campaign groups or to others in the company may be displayed on the field user's device. In some cases, the system may generate a relative progress toward an award between multiple field users and transmit an indication of the relative progress to the multiple field users. Such information may provide motivation or create competition between field users to generate a greater number of leads, which benefits the company. Information displayed can include real-time information relating to the number of leads generated, various incentives or awards earned, or other information.

Campaigns can be created by the company and assigned to one or more campaign groups within the company. In one embodiment, when interacting with a new lead, a field user within a campaign group can choose amongst the various campaigns made available to the field user, and select a specific campaign to offer to the new lead.

As described above, FIG. 5 shows an example set of promotions and campaigns that could be used with embodiments of the present disclosure. The example campaigns may define a discount offer rate, other type of promotion, and/or a follow-up time schedule for sending promotional or other electronic communications to leads. For instance, Campaign Number 1 may be 30% off any purchase by a new customer, with follow-up emails sent to the new customer 3, 5, and 10 days later; Campaign Number 2 may be 20% off a purchase for a new customer, with follow-up emails sent to the new customer 3, 5, and 10 days later; and Campaign Number 3 may be 10% off a purchase for a new customer, with follow-up emails sent to the new customer 3, 5, and 10 days later. It is understood that these promotions are provided by way of example only, and that various other promotions may be utilized depending upon the particular implementation.

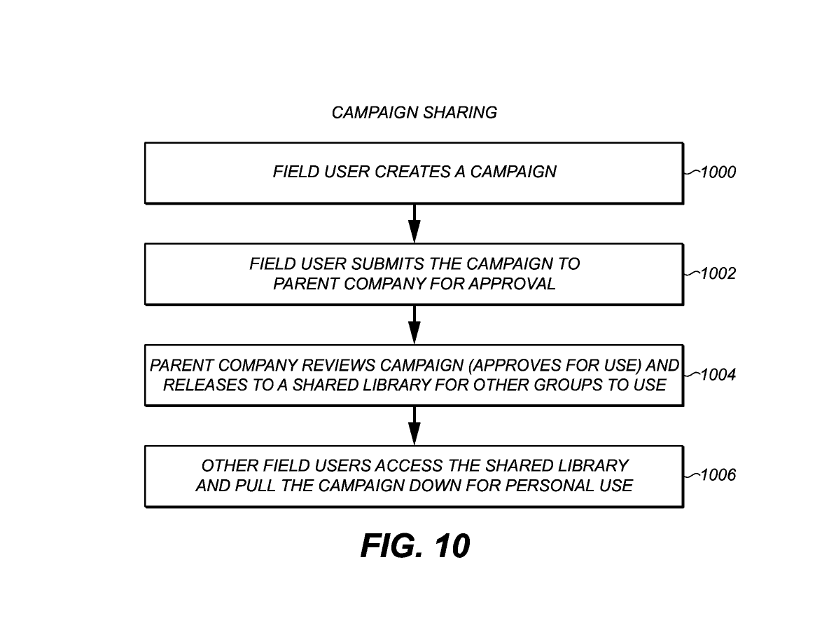

FIG. 10 illustrates various examples of campaign sharing, in accordance with one embodiment of the present invention. At operation 1000, a field user may create a campaign which may include a new promotion or offer to make to leads. At operation 1002, the field user submits that campaign to the company for approval. In one example, the field user may enter the campaign into the application program of their mobile device, and the campaign is transmitted to the lead engine which transmits the campaign to the account administrator for the company.

At operation 1004, the company reviews, revises (if desired) and approves the campaign, and posts or releases the campaign to campaign groups for use by the field users. In one example, the campaigns available to field users are maintained in libraries that are accessed by authorized campaign groups and the field users of those campaign groups.

At operation 1006, the field users access the campaign and utilize the campaign for any leads that they meet. In this manner, the operations of FIG. 10 illustrate a feature of an embodiment of the present invention wherein campaigns can be created by field users and distributed to other field users. This can help promote innovation within a company as to the creation of new campaigns/promotions for generating new leads for the company.

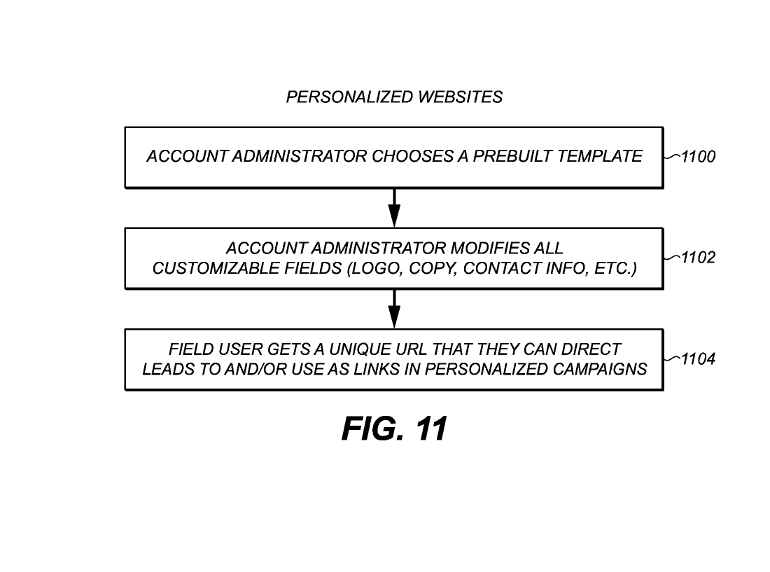

FIG. 11 illustrates various examples of creating personalized websites (e.g., field-user-specific websites), in accordance with one embodiment of the present invention. At operation 1100, a prebuilt template of websites may be created and provided to an administrator. The administrator can, through their computing device, choose a particular website template. At operation 1102, the account administrator can customize various fields of the template, to suit the company and its products, services or promotions. In some cases, the template may be modified or defined in accordance with field-user data accessed through the company-based administrator computing system. At operation 1104, with the website templates being configured, operation 1104 transmits to the field users a URL that is unique to the field user, wherein the field user can provide at least one user-selected option. For example, the field user may further customize/personalize the web page with specific information about the field user such as their photo, email address, phone number, etc., as well as with embedded links to promotions and offers, as desired by the field user. As described herein, the field user can then transmit or cause the transmission of the URL of the personalized web page to a lead, wherein the lead can then view such personalized webpage and take action using any of the embedded links on the personalized web page with promotions or offers.

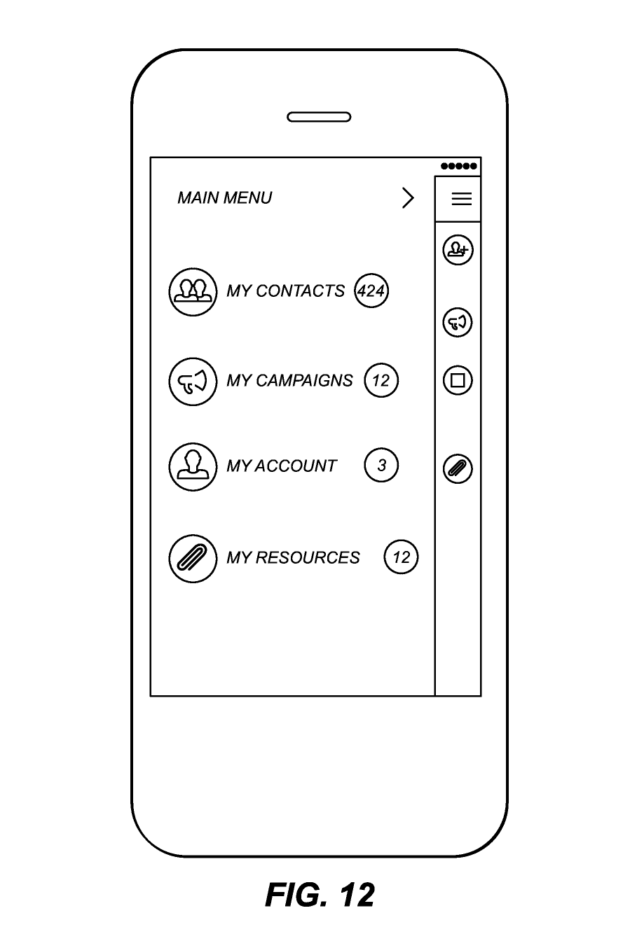

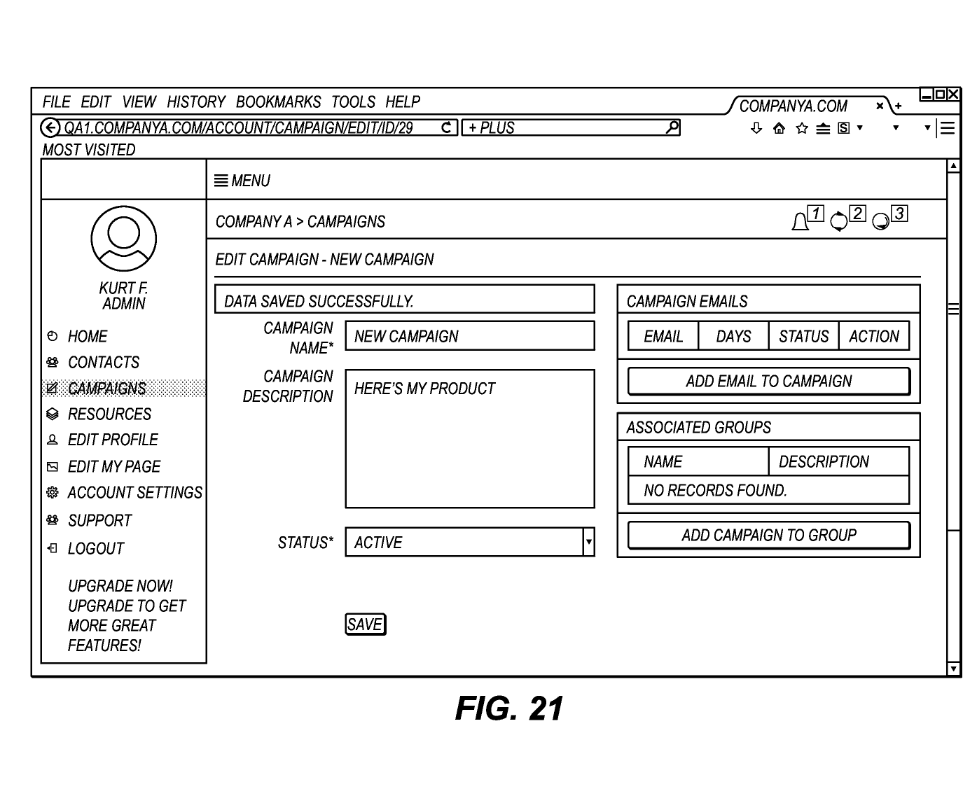

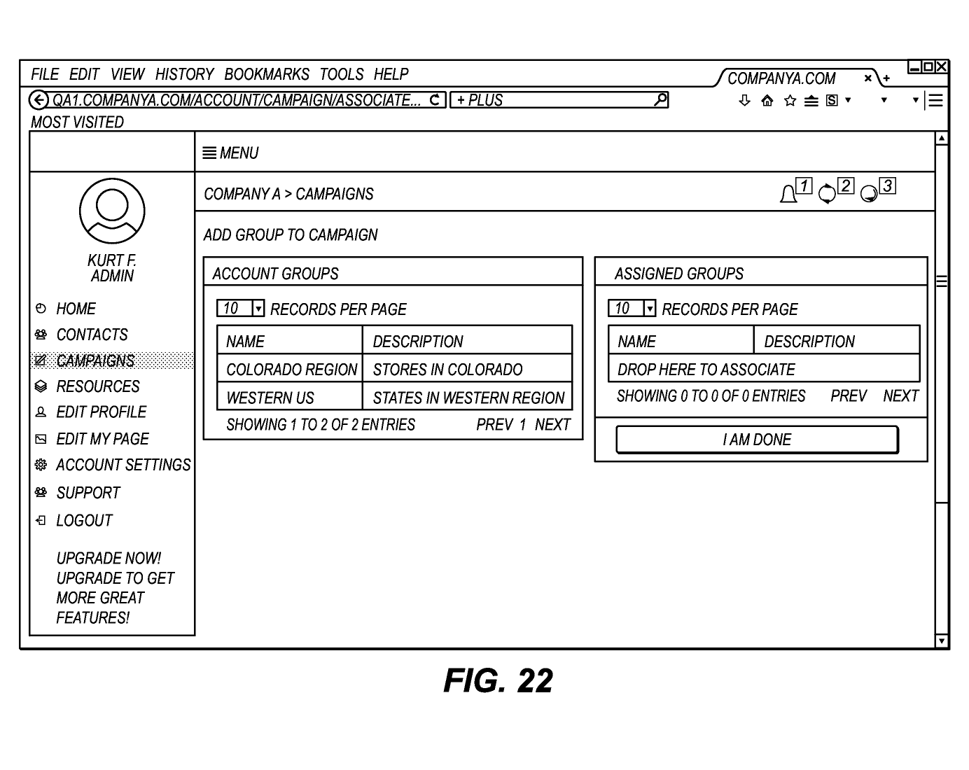

FIGS. 12-25 illustrate various examples of computer display screens illustrating various features of embodiments of the present invention.

FIG. 12 shows an example of a mobile device display for a field user, showing a main menu with controls for managing the field user's contacts, campaigns, account, and resources. This may be part of a lead-generation application program described above.

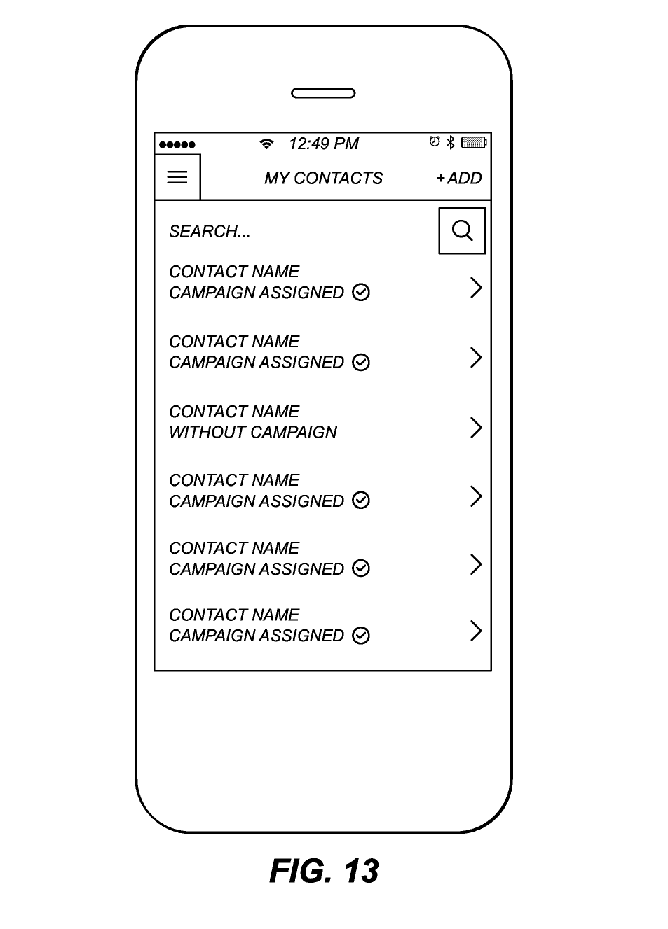

FIG. 13 shows an example of a mobile device display for a field user, showing a menu with controls for managing the field user's various contacts, including the campaigns assigned to each contact. The controls shown in FIG. 13 (which may be part of a lead-generation application program described above) can be configured to allow a field user to enter contact persons/leads into their mobile device, and then to assign one or more campaigns to a lead/contact person. In one example, the campaigns selected by the field user to be assigned to the lead/contact person will be sent to the lead/contact person electronically (such as in the form of an email, text message, url or other electronic means) by the lead engine/server.

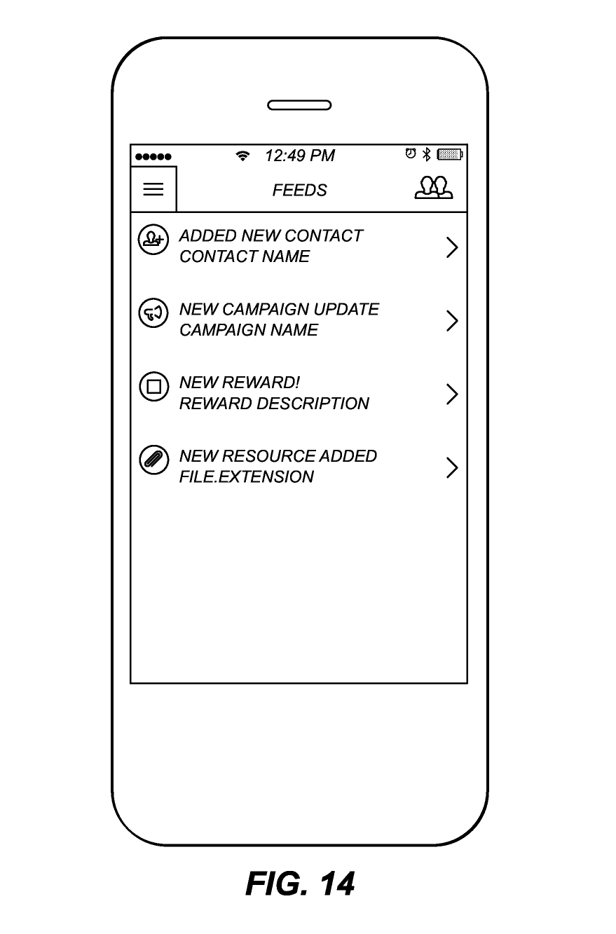

FIG. 14 shows an example of a mobile device display for a field user, showing a menu with controls for managing the field user's new contacts, new campaigns, new awards, and new resources. This may be part of a lead-generation application program described above.

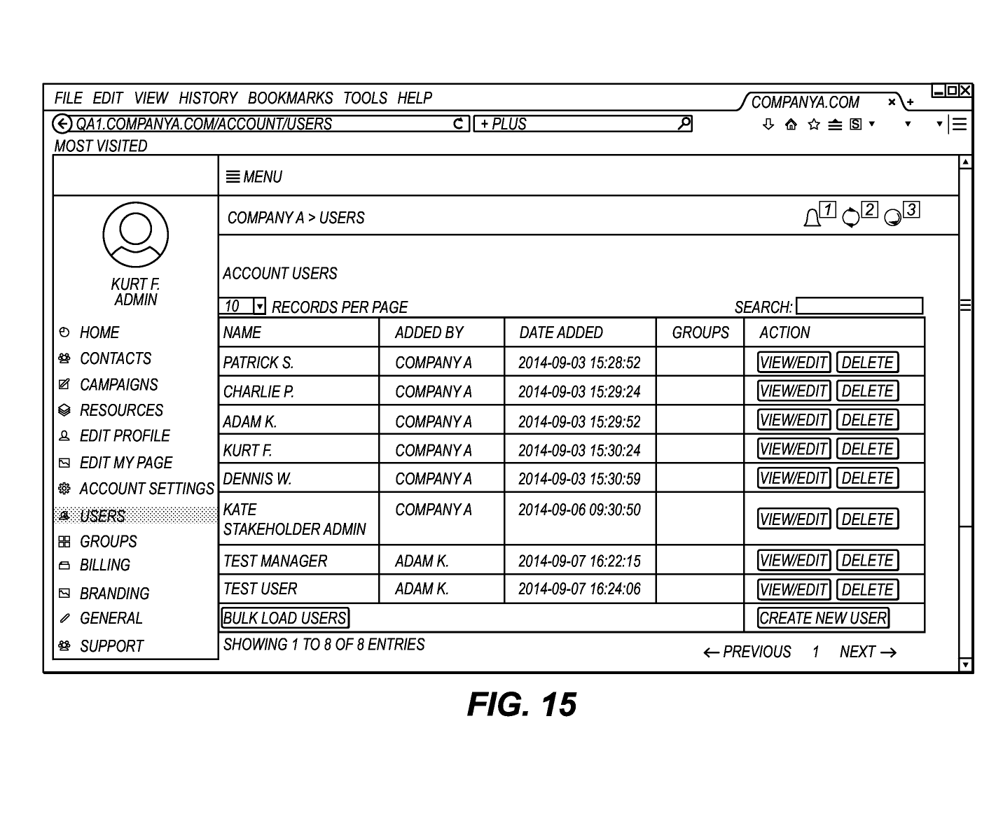

FIGS. 15-25 illustrate various examples of display screens that may be provided by the lead engine to an administrator of a company, in order to manage the various field user accounts and leads generated by field users, and other functions and processes as described herein.

FIG. 15 shows an example of a computer display screen with controls for an administrator to manage various field user accounts and to create new field user accounts for a company. The computer display screen of FIG. 15 may be executed on an administrator computing system similar to the example provided above with respect to FIG. 1. The input display of FIG. 15 may be used to enter data which may for part of the field user data described herein with respect to various embodiments. In some cases, the field user data may be used to associate the field user with one or more user or campaign groups.

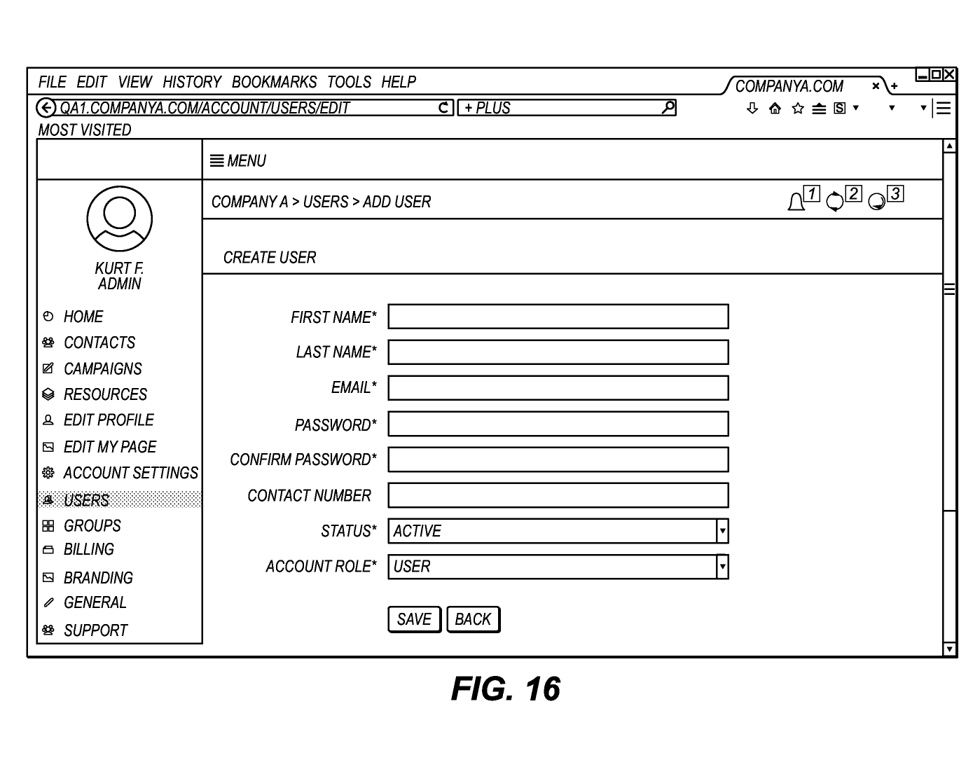

FIG. 16 shows an example of a computer display screen with controls for an administrator to create new field user accounts for a company, including fields for entering data relating to a field user such as name, email address, etc. The computer display screen of FIG. 16 may be executed on an administrator computing system similar to the example provided above with respect to FIG. 1. The input display of FIG. 16 may be used to enter new field user data described herein with respect to various embodiments.

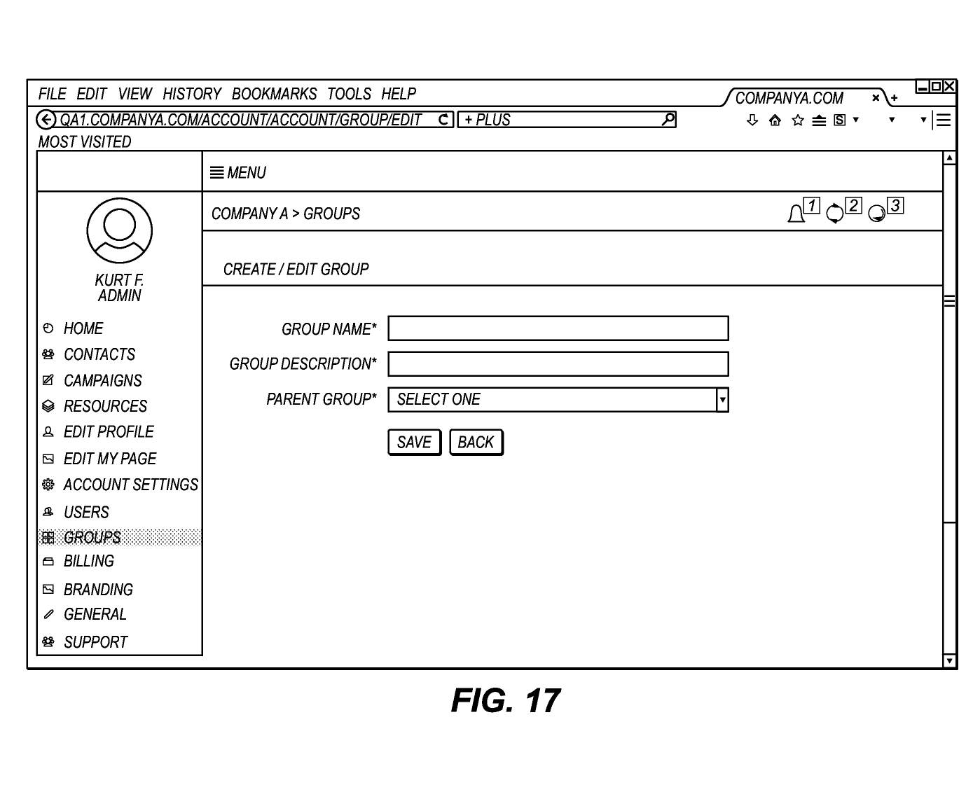

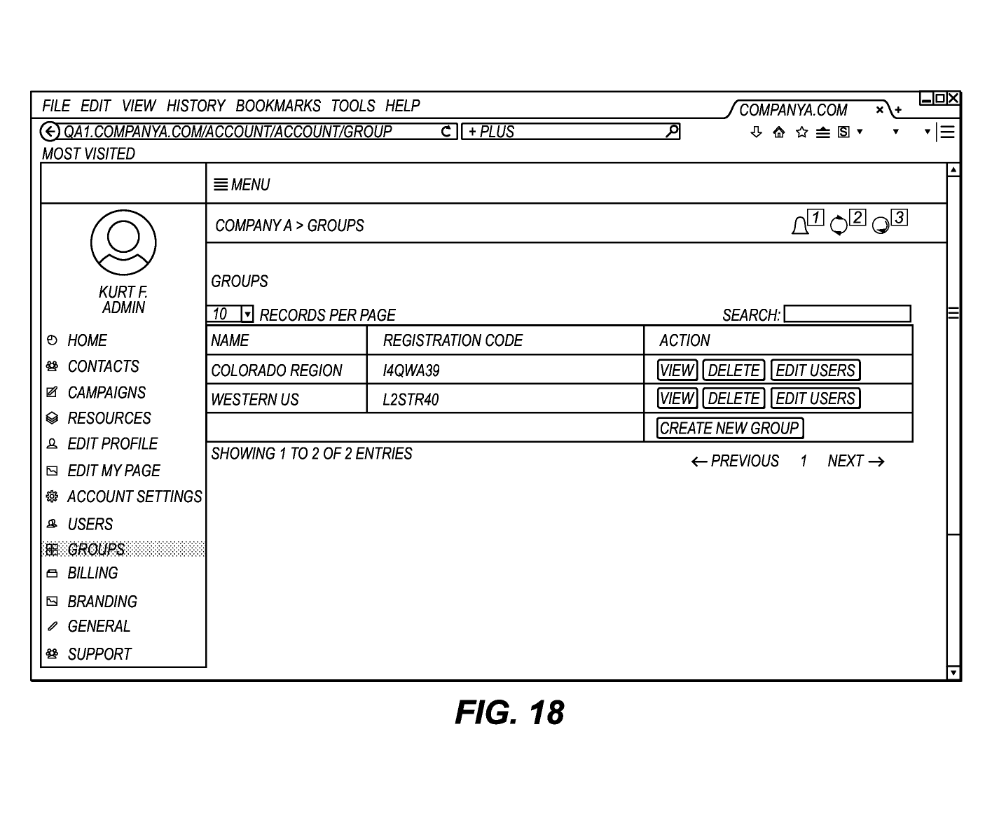

FIGS. 17-18 show examples of computer display screens with controls for an administrator to manage various campaign groups of field users, and to create new field campaign groups and edit the field campaign groups. The display of FIGS. 17-18 may be executed on an administrator computing system and may be generated in accordance with definitions or forms provided by the lead-engine server. In some implementations, the data entered using the displays of FIGS. 17-18 may be transmitted to the lead-engine server and used to associate or assign field users to one or more user groups or campaign groups in accordance with the information entered using the displays of FIGS. 17-18.

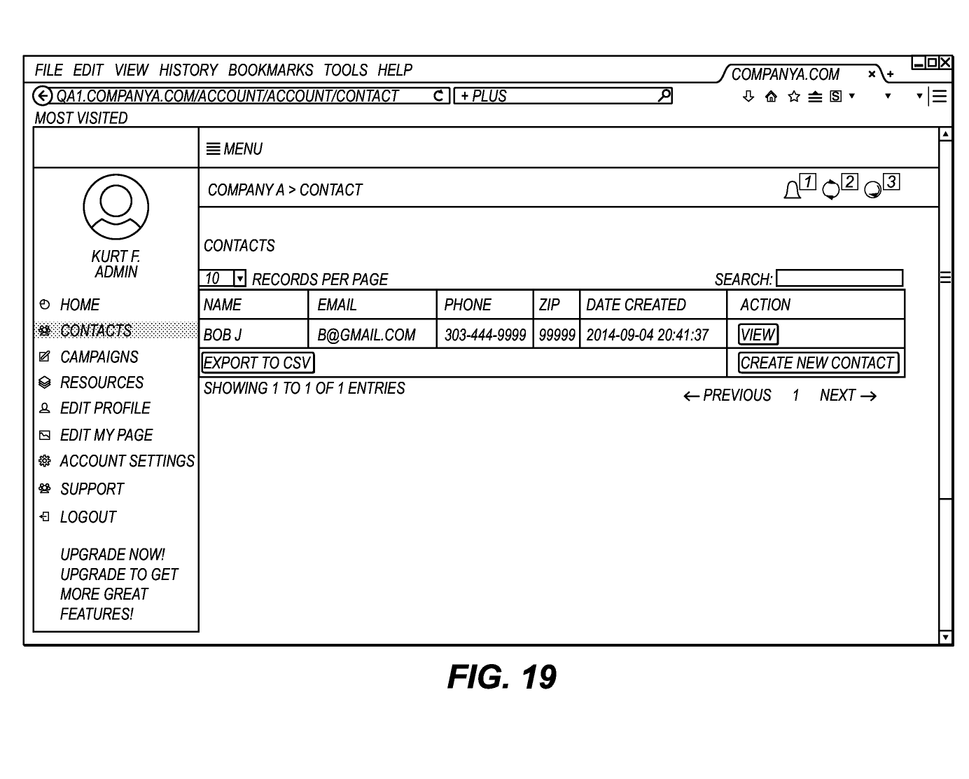

FIG. 19 shows an example of a computer display screen with controls for an administrator to manage and create new contacts, including fields for data relating to a contact such as name, email address, phone, etc. The fields populated in FIG. 19 may also represent example lead-generation data that was entered by a field user using a mobile device. The lead-generation data may be updated using the display of FIG. 19. The display of FIG. 19 may also be used to export or transfer the lead-generation data to one or more systems, databases, and/or other platforms.

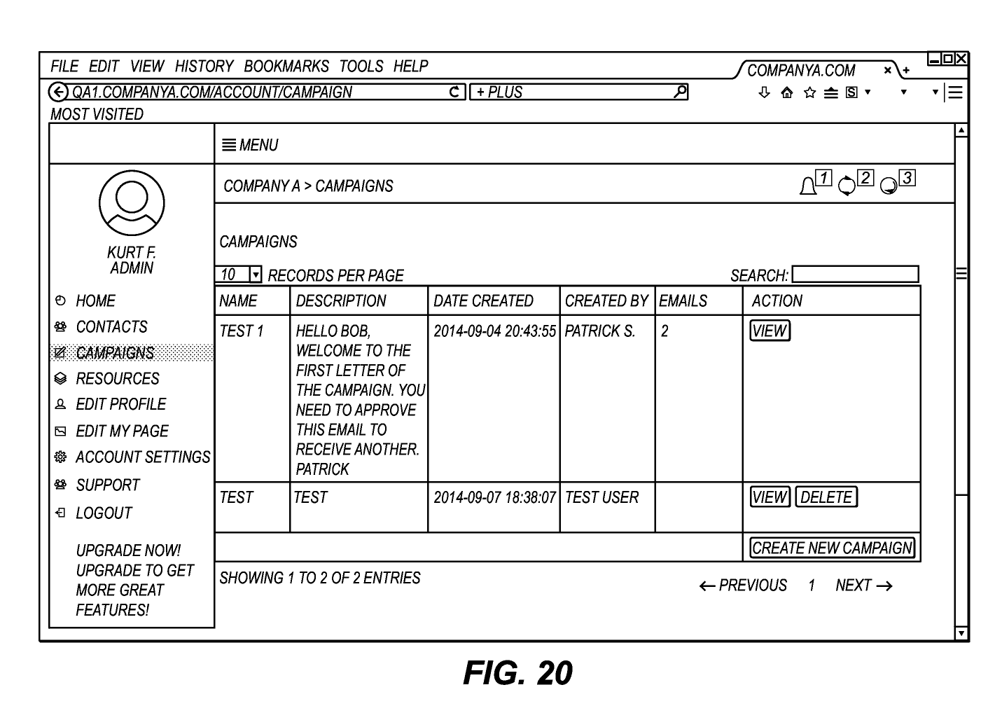

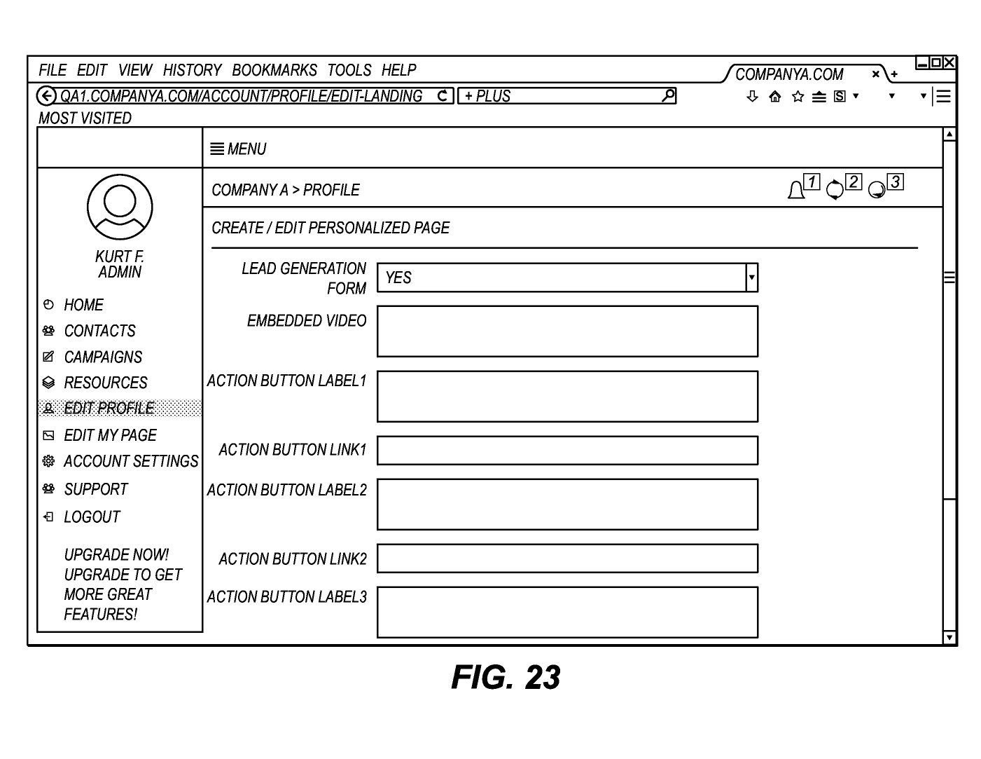

FIGS. 20-22 show examples of computer display screens with controls for an administrator to manage, edit and create new campaigns or promotions, including controls to add form/template emails for a campaign, and adding or associating a campaign with a campaign group. The campaigns or campaign forms may be initially defined by the lead-engine server and transmitted to an administrator computing system for further editing or approval. Information entered or approved using the display of FIG. 23 may be transmitted back to lead-engine server for use in the system. The campaigns defined or confirmed using the display of FIG. 23 may be used to transmit various promotional offers and/or other promotional communications in accordance with a predefined follow-up time schedule or other predefined promotional communication timeline.

FIG. 23 shows an example of a computer display screen with controls for an administrator to create and edit a personalized web page or website for a field user. As described above with respect to some embodiments, a web page or website may be defined based on field user data and one or more options selected by the field user. In some embodiments, the options or information provided by the administrator may be transmitted to a field user for approval or for selection of one or more additional options or customizations. As shown in FIG. 23, the personalized web page or website may include custom embedded videos, custom URL links and one or more action buttons. In accordance with some embodiments, the administrator or other operator may be able to track activity and/or transactions associated with the personalized web page or website.

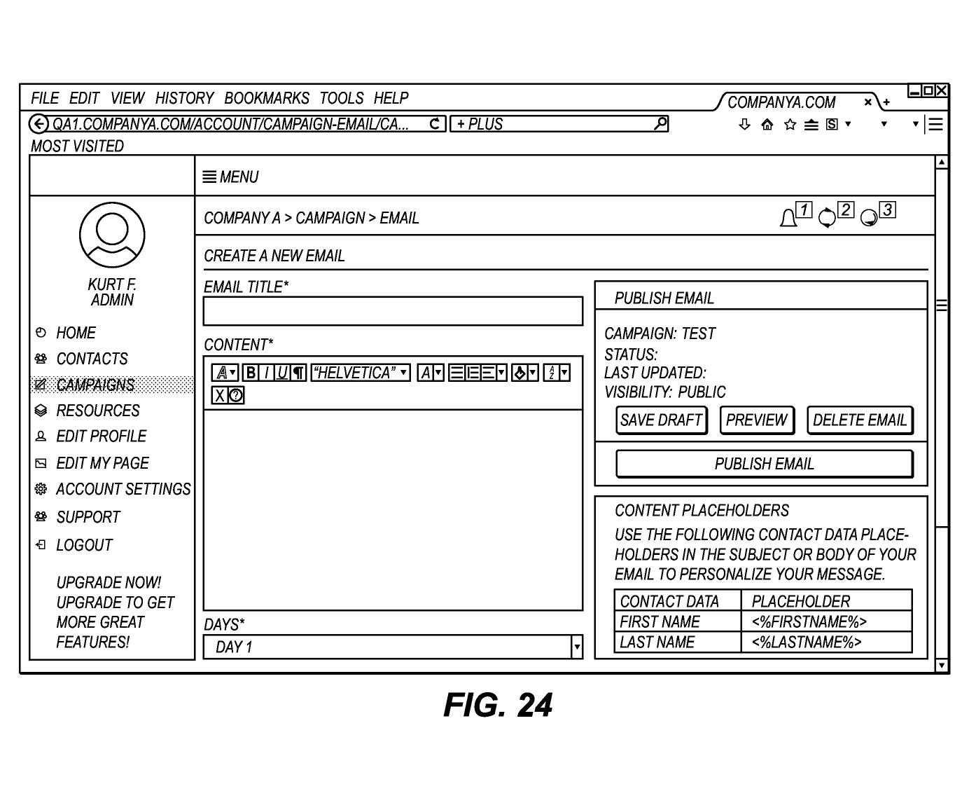

FIG. 24 shows an example of a computer display screen with controls for an administrator to create and publish e-mail templates for promotions or campaigns. The template e-mail may be transmitted to the mobile device of the field user, who may complete the template and send the e-mail to one or more leads. In some embodiments, the template e-mail is used to automatically generate e-mails directly to one or more leads using the lead-generation data or input collected by the system.

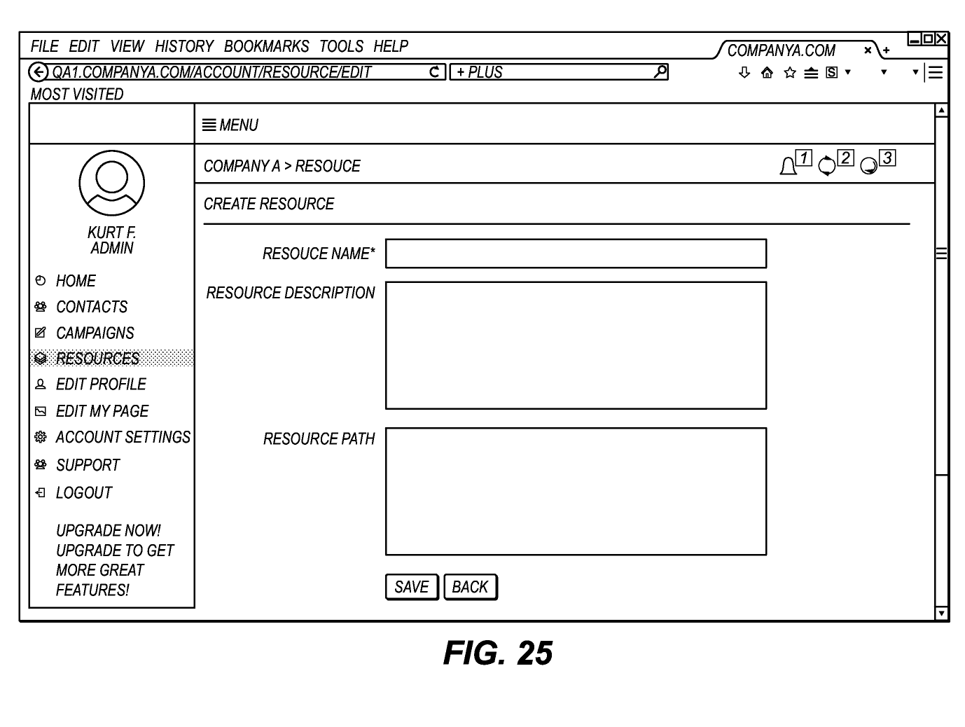

FIG. 25 shows an example of a computer display screen with controls for an administrator to create, and make available to field users, a resource such as an article, white paper, notice, update, video clip, marketing item or other type of electronic data, for use by field users to provide information to leads. In some embodiments, the information added using the display of FIG. 25 is transmitted to the field user, who may e-mail or otherwise communicate the information to a lead or group of leads. In some embodiments, the information is transmitted directly to the lead or group of leads without sending to the respective field user.

Hence, it can be seen that embodiments of the present invention provide for enhancing generation of leads by providing an electronic, computer-implemented framework and methods for field users to engage prospective leads.

As an example, assume a field user is outside their place of business, going about their daily life at a party, or at a grocery store, out to lunch or on an airplane. They strike up a conversation with a friend, a family member or more likely a complete stranger. As the conversation continues, the topic of work comes up, and the conversation turns to a discussion about how the person could benefit from the user's company or services. The field user has the opportunity to open a mobile app on their phone or tablet, select from a list of preformatted campaigns, and send the new “prospect” a personalized series of emails with a marketing message or special offer which appears to have been created just for them. The links which are automatically embedded in the e-mail campaigns and can include videos or PDFs included and these would be viewed inside of the account user's personalized site. This creates a level of personalization from the beginning of the exposure process to the end. The new prospect/lead is then captured in a centralized database on the server and/or database and stored for future marketing activities.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed is:

1. A computer-implemented lead-management system comprising:
a lead-engine server operatively coupled to an administrator computing system, the lead-engine server configured to:
assign field user data among multiple campaign groups, the field user data associated with multiple field users and received from the administrator computing system;
define a first campaign for a first group of the multiple campaign groups;
define a second campaign for a second group of the multiple campaign groups, the second campaign different from the first campaign;
for a first field user associated with the first group, generate an incentive program that defines an award associated with a threshold level of lead-generation input associated with the first field user; and
track the lead-generation input associated with the first field user; and
a group of mobile devices operatively coupled to the lead-engine server by a computer network, the group of mobile devices configured to:
receive the lead-generation input from a respective field user; and
transmit the lead-generation input to the lead-engine server.

2. The computer-implemented system of claim 1, wherein:
the lead-engine server is further configured to:
generate an electronic lead-generation form for the first field user; and
transmit the lead-generation form to a mobile device associated with the first field user; and
the mobile device is configured to:
receive the lead-generation form;
add the lead-generation input using an input display based on the lead-generation form; and
transmit the lead-generation input to the lead-engine server.

3. The computer-implemented system of claim 1, wherein:
the incentive program defines:
the award which is a first award associated with a first threshold number of new leads tracked using the lead-generation input;
a second award associated with a second threshold number of new leads; and
a third award associated with a third threshold number of new leads.

4. The computer-implemented system of claim 1, wherein:
the first campaign comprises:
a first discount offer rate; and
a first follow-up time schedule; and
the second campaign comprises:
a second discount offer rate different from the first discount offer rate; and
a second follow-up time schedule different from the first follow-up schedule.

5. The computer-implemented system of claim 1, wherein the lead-generation input includes contact information for a lead, the contact information including one or more of:
a lead name;
an e-mail address;
a company name; or
a telephone number.

6. The computer-implemented system of claim 1, wherein the first group is defined based on one or more of the following:
a job title of a field user;
a company of the field user; or
a geographic region of the field user.

7. The computer-implemented system of claim 1, wherein:
the lead-engine server is further configured to generate a field-user-specific website using the user field data and at least one user-selected option; and
the lead-engine server is further configured to transmit a link to the field-user-specific website to a lead.

8. A computer-implemented lead management system comprising:
a mobile device operatively coupled to a lead-engine server via a computer network, the mobile device configured to:
receive a campaign selection from a field user;
display an input display based on a lead-generation form received from the lead-engine server over the computer network;
receive lead-generation input using the input display; and
transmit the lead-generation input to the lead-engine server using the computer network, wherein the lead-engine server is configured to transmit a promotional communication to a lead associated with the lead-generation input in accordance with the campaign selection.

9. The computer-implemented system of claim 8, wherein the lead-engine server is further configured to receive the lead-generation input and credit an incentive to the field user based on a number of new leads.

10. The computer-implemented system of claim 9, wherein the lead-engine server further configured to:
generate a first award when the number of new leads exceeds a first threshold; and
generate a second award when the number of new leads exceeds a second threshold that is greater than the first threshold.

11. The computer-implemented system of claim 9, wherein the lead-engine server is further configured to:
generate a relative progress toward an award between multiple field users; and
transmit an indication of the relative progress to the multiple field users.

12. The computer-implemented system of claim 8, wherein:
the lead-engine server is further configured to generate a field-user-specific website using at least one user-selected option; and
the promotional communication includes a link to the field-user-specific website.

13. The computer-implemented system of claim 12, wherein the lead-engine server is further configured to track activity on the field-user-specific website.

14. The computer-implemented system of claim 8, wherein the lead-engine server is further configured to track purchase activity related to the promotional communication.

15. The computer-implemented system of claim 8, wherein:
the promotional communication includes a discount rate associated with the campaign selection.

16. The computer-implemented system of claim 8, wherein the lead-engine server is configured to transmit subsequent promotional communications in accordance with a communication schedule associated with the campaign selection

17. A computer-implemented system for generating customer leads over a network, comprising:
a plurality of mobile devices operatively coupled to the network, the mobile devices having a processor configured to:
display to a field user one or more promotions for offering to a lead; and
receive lead-generation input from the field user;
a server coupled to the network, the server having a lead engine configured to:
receive the lead-generation input from the mobile devices; and
transmit one or more promotions to each lead; and
a database coupled with the server, the database configured to store the lead-generation input and promotional information associated with one or more promotions.

18. The computer-implemented system of claim 17, wherein the promotional information includes a link to a field-user-specific website.

19. The computer-implemented system of claim 17, wherein:
the server is configured to define multiple promotional campaigns, each promotional campaign associated with a different group of field users;
the promotion is defined in accordance with a promotional campaign that is associated with the field user that received the lead-generation input.

20. The computer-implemented system of claim 17, wherein:
the server is configured to track lead-generation input received from the plurality of mobile devices; and
the server is configured to update a progress for each mobile device using the lead-generation input.

21. The computer-implemented system of claim 17, wherein the server is further configured to:
generate a relative progress between two or more field users based on the received lead-generation input; and
transmit an indication of the relative progress to the two or more field users.
